(19) United States
(12) Patent Application Publication
(10) Pub. No.: US 2011/0068888 A1
(43) Pub. Date: Mar. 24, 2011

(54) HIGH VOLTAGE TRANSFORMER EMPLOYED IN AN INVERTER

(75) Inventors: CHIH-CHAN GER, Jhongli City (TW); CHIA-KUN CHEN, Jhongli City (TW)

(73) Assignee: AMPOWER TECHNOLOGY CO., LTD., Jhongli City (TW)

(21) Appl. No.: 12/957,421

(22) Filed: Dec. 1, 2010

Related U.S. Application Data
(62) Division of application No. 12/506,449, filed on Jul. 21, 2009.

(30) Foreign Application Priority Data
Jul. 25, 2008 (CN) 200820095776.6
Jun. 1, 2009 (CN) 200920303883.8

(51) Int. Cl. H01F 27/28

(52) U.S. Cl. 336/220

(57) ABSTRACT

A high voltage transformer employed in an inverter includes a first core and a second core. The second core is coupled to the first core. The second core is wrapped by at least one primary winding and at least one secondary winding of the transformer. The first core is made of manganese-zinc alloy, and the second core is made of nickel-zinc alloy, so as to achieve that conductive coefficient of the first core is much higher than conductive coefficient of the second core.

### CROSS-REFERENCE TO RELATED APPLICATIONS

This application is a divisional application of co-pending application Ser. No. 12/506,449, filed Jul. 21, 2009.

### BACKGROUND

1. Technical Field

The present disclosure relates to a high voltage transformer for an inverter.

2. Description of Related Art

Normally, magnetic components, such as transformers, are used in electronic devices. For example, transformers used in inverters of liquid crystal displays (LCDs) convert received voltage signals into high voltage signals adapted for the LCDs.

In order to avoid the requirement for secondary windings on the transformers to discharge to cores of the transformers, distance between either the bobbins and cores can be increased, or the cores can be fabricated of non-conductive material, such as a nickel-zinc alloy. However, in the first case, height of the transformers must be increased, impairing industry preferences for the LCDs to be light and small. In the second case, the specialized fabrication material increases costs.

### BRIEF DESCRIPTION OF THE DRAWINGS

FIG. 1 is a schematic diagram of a first embodiment of a high voltage transformer of the present disclosure.

FIG. 2 is a schematic diagram of a second embodiment of a high voltage transformer of the present disclosure.

FIG. 3 is a schematic diagram of a third embodiment of a high voltage transformer of the present disclosure.

FIG. 4 is a schematic diagram of a fourth embodiment of a high voltage transformer of the present disclosure.

FIG. 5 is a schematic diagram of a fifth embodiment of a high voltage transformer of the present disclosure.

FIG. 6 is a schematic diagram of a sixth embodiment of a high voltage transformer of the present disclosure.

FIG. 7 is a schematic diagram of a seventh embodiment of a high voltage transformer of the present disclosure.

FIG. 8 is a schematic diagram of a eighth embodiment of a high voltage transformer of the present disclosure.

FIG. 8A is a side view of FIG. 8.

FIG. 9 is a schematic diagram of a ninth embodiment of a high voltage transformer of the present disclosure.

FIG. 10 is a schematic diagram of a tenth embodiment of a high voltage transformer of the present disclosure.

FIG. 11 is a schematic diagram of a eleventh embodiment of a high voltage transformer of the present disclosure.

FIG. 12 is a schematic diagram of a twelfth embodiment of a high voltage transformer of the present disclosure.

FIG. 13 is a schematic diagram of a thirteenth embodiment of a high voltage transformer of the present disclosure.

FIG. 14 is a schematic diagram of a fourteenth embodiment of a high voltage transformer of the present disclosure.

FIG. 15 is a schematic diagram of a fifteenth embodiment of a high voltage transformer of the present disclosure.

FIG. 16 is a schematic diagram of a sixteenth embodiment of a high voltage transformer of the present disclosure.

FIG. 17 is a schematic diagram of a seventeenth embodiment of a high voltage transformer of the present disclosure.

FIG. 18 is a schematic diagram of a eighteenth embodiment of a high voltage transformer of the present disclosure.

FIG. 19 is a schematic diagram of a nineteenth embodiment of a high voltage transformer of the present disclosure.

FIG. 20 is a schematic diagram of a twentieth embodiment of a high voltage transformer of the present disclosure.

FIG. 20A is a schematic diagram of a twenty-first embodiment of a high voltage transformer of the present disclosure.

FIG. 20B is a schematic diagram of a twenty-second embodiment of a high voltage transformer of the present disclosure.

FIG. 21 is a schematic diagram of a twenty-third embodiment of a high voltage transformer of the present disclosure.

FIG. 22 is a schematic diagram of a twenty-fourth embodiment of a high voltage transformer of the present disclosure.

### DETAILED DESCRIPTION

In all embodiments of the disclosure, cores are accepted in bobbins (not shown) in transformers, and primary windings and secondary windings are applied on corresponding regions of the bobbins. For brevity, the bobbins are omitted, and the primary and secondary windings are described as applied to the cores directly.

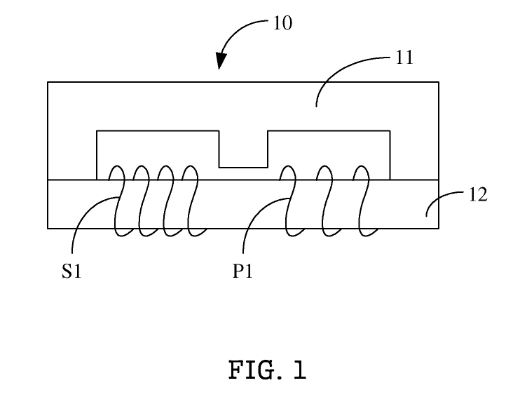

FIG. 1 is a schematic diagram of a first embodiment of a high voltage transformer 10. The transformer 10 comprises a first core 11 and a second core 12 coupled to the first core 11. In one embodiment, the first core 11 is an “M” type core and the second core 12 an “I” type core. One end of the second core 12 is wrapped by a primary winding P1, and the other end thereof is wrapped by a secondary winding S1. In other words, the cores 11, 12 of the high voltage transformer 10 form a “MI” type core assembly. As illustrated, conductive coefficient of the first core 11 is at least 100 times of that of the second core 12. The first core 11 is made of manganese-zinc (MZ) alloy, and the second core 12 is made of nickel-zinc (NZ) alloy.

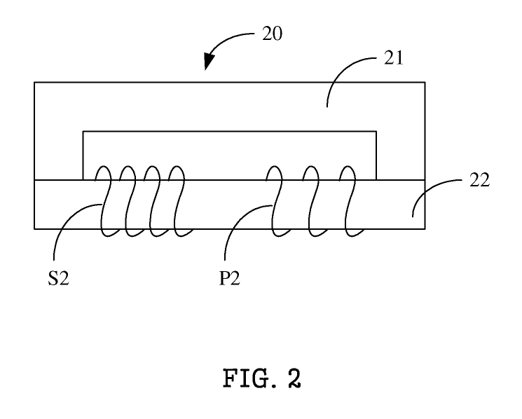

FIG. 2 is a schematic diagram of second embodiment of a high voltage transformer 20, differing from high voltage transformer 10 in that a first core 21 of the high voltage transformer 20 is a “C” type core, that is, the cores 21, 22 of the high voltage transformer 20 form a “CI” type core assembly.

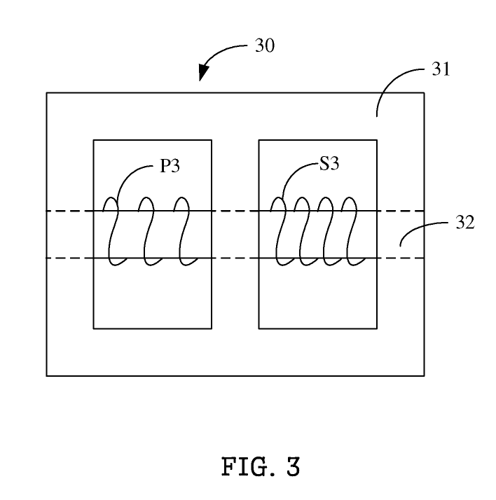

FIG. 3 is a schematic diagram of a third embodiment of a high voltage transformer 30, differing from high voltage transformer 10 in that a first core 31 of the high voltage transformer 30 is a “ [symbol] ” type core, that is, the cores 31, 32 of the high voltage transformer 20 form a “ [symbol] I” type core assembly.

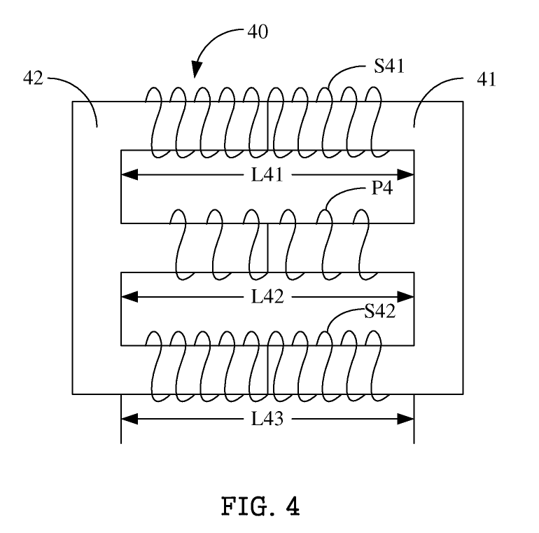

FIG. 4 is a schematic diagram of a fourth embodiment of a high voltage transformer 40. The high voltage transformer 40 comprises a first core 41 and a second core 42, both of which are “E” type cores, arranged face to face to form a “ [symbol] ” type core assembly. Similarly, conductive coefficient of the first core 41 is at least 100 times of that of the second core 42. The first core 41 is made of manganese-zinc alloy, and the second core 42 is made of nickel-zinc alloy. The “ [symbol] ” type core assembly comprises a first leg L41, a second leg L42 and a third leg L43. The first leg L41 and the third leg L43 are wrapped by secondary windings S41, S42, respectively. The second leg L42 is wrapped by a primary winding P4. In one embodiment, the first, second, and third legs L41, L42, L43 are the same length.

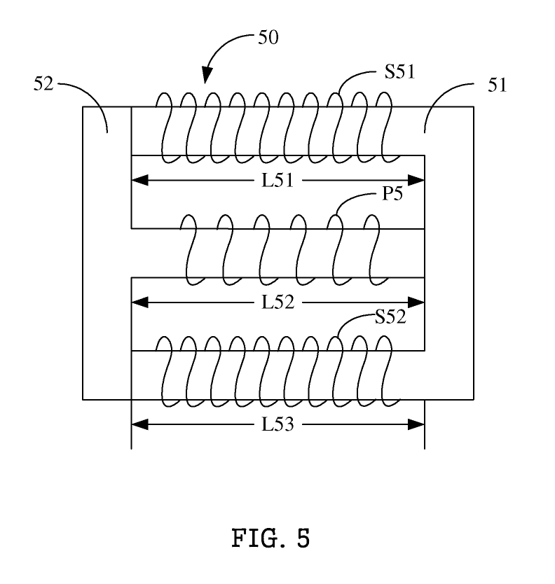

FIG. 5 is a schematic diagram of a fifth embodiment of a high voltage transformer 50, differing from high voltage transformer 40 in that a first core 51 of the high voltage transformer 50 is a “C” type core, and a second core 52 is a “T” type core, that is, the cores 51, 52 of the high voltage transformer 50 form a “CT” type core assembly.

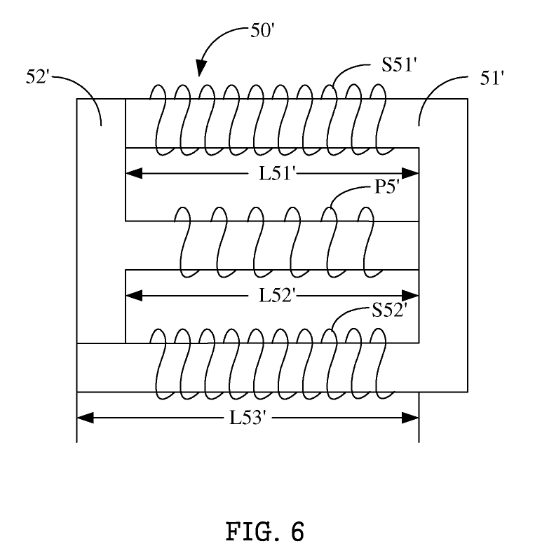

FIG. 6 is a schematic diagram of a sixth embodiment of a high voltage transformer 50′, differing from high voltage transformer 50 in that legs L51′, L52′ L53′ are different length. In detail, the first leg L51′ and the second leg L52′ are the same length, being shorter than third leg L53′.

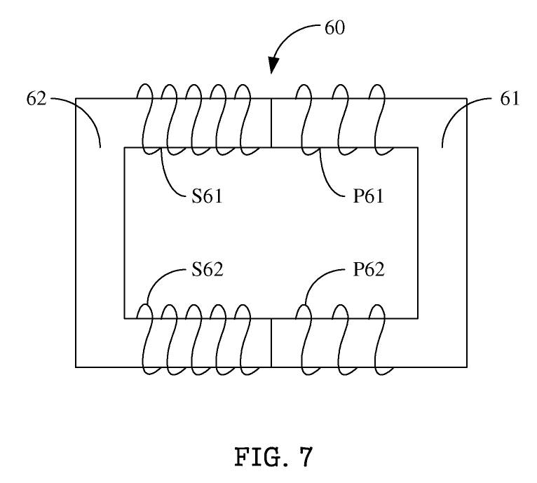

FIG. 7 is a schematic diagram of a seventh embodiment of a high voltage transformer 60. The high voltage transformer 60 comprises a first core 61 and a second core 62, both of which are “U” type cores and arranged face to face. In one embodiment, the first core 61 is wrapped by primary windings P61, P62, and the second core 62 is wrapped by secondary windings S61, S62. Similarly, conductive coefficient of the first core 61 is at least 100 times of that of the second core 62. The first core 61 is made of manganese-zinc alloy, and the second core 62 is made of nickel-zinc alloy.

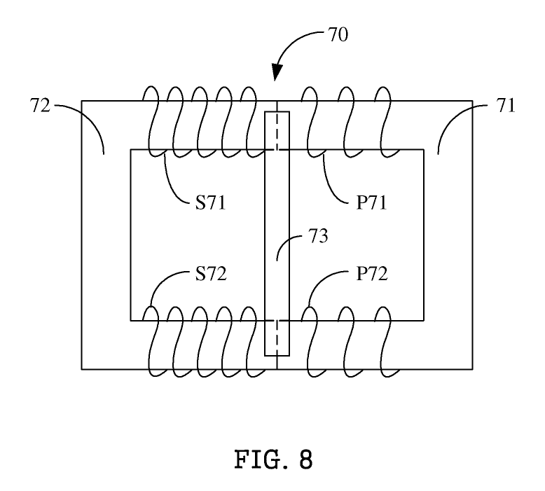

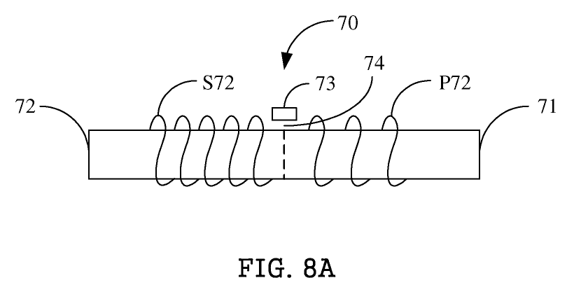

FIG. 8 is a schematic diagram of an eighth embodiment of a high voltage transformer 70, differing from high voltage transformer 60 in that the high voltage transformer 70 comprises at least one “I” type core disposed on “U” type cores 71, 72 to form a “ [symbol] ” type core assembly. In one embodiment, there is at least one air gap 74 (referring to FIG. 8A) between a plane of the “I” type core 73 and a plane of the “U” type cores 71, 72, to adjust leakage inductance of the high voltage transformer 70.

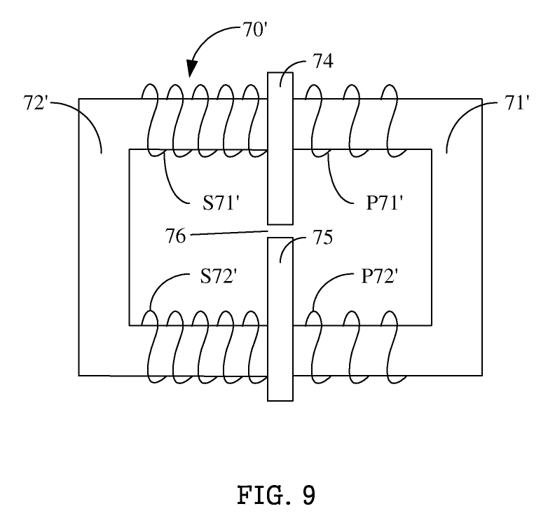

FIG. 9 is a schematic diagram of a ninth embodiment of a high voltage transformer 70′, differing from high voltage transformer 70 in that high voltage transformer 70′ comprises two “I” type cores 74, 75 disposed between the “U” type cores 71′, 72′. Similarly, an air gap 76 between the two “I” type cores 74, 75 and the “U” type cores 71′, 72′, adjusts leakage inductance of the high voltage transformer 70′.

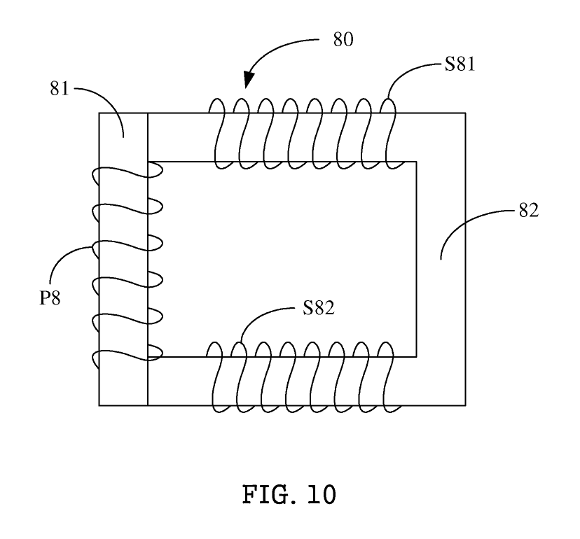

FIG. 10 is a schematic diagram of a tenth embodiment of a high voltage transformer 80, differing from high voltage transformer 60 of FIG. 7 in that a first core 81 and a second core 82 of the high voltage transformer 80 form an “IC” type core assembly.

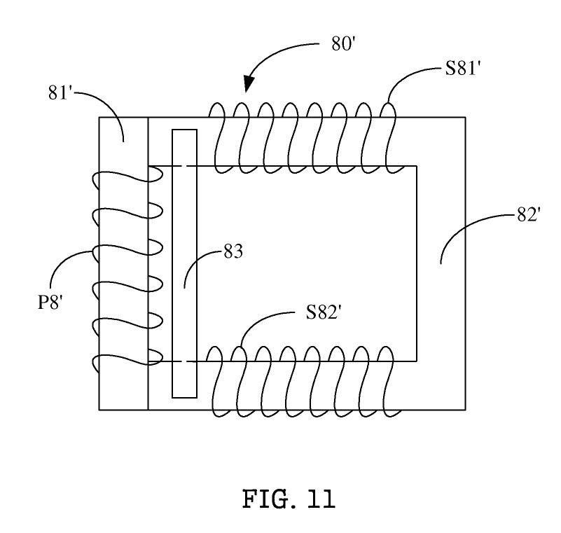

FIG. 11 is a schematic diagram of an eleventh embodiment of a high voltage transformer 80′, differing from high voltage transformer 80 in that the high voltage transformer 80′ comprises a third core 83. In one embodiment, the third core 83 is a “I” type core, disposed on the first and second cores 81′, 82′, which forms a “ [symbol] ” type core assembly.

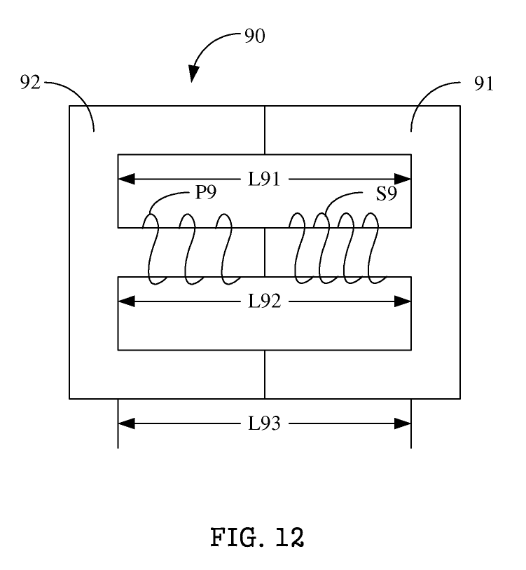

FIG. 12 is a schematic diagram of a twelfth embodiment of a high voltage transformer 90. The high voltage transformer 90 comprises a pair of “E” type cores 91, 92. The cores 91, 92 are arranged face to face and form a “ [symbol] ” type core assembly comprising a first leg L91, a second leg L92, and a third leg L93. As illustrated, the second leg L92 is wrapped by a primary winding P9 and a secondary winding S9. In detail, the primary winding P9 is wrapped on the “E” type core 92 of the second leg L92, and the secondary winding S9 is wrapped on the “E” type core 91 of the second leg L92. Similarly, conductive coefficient of the core 91 is at least 100 times of that of the core 92. The core 61 is made of a manganese-zinc alloy, and the core 62 is made of a nickel-zinc alloy.

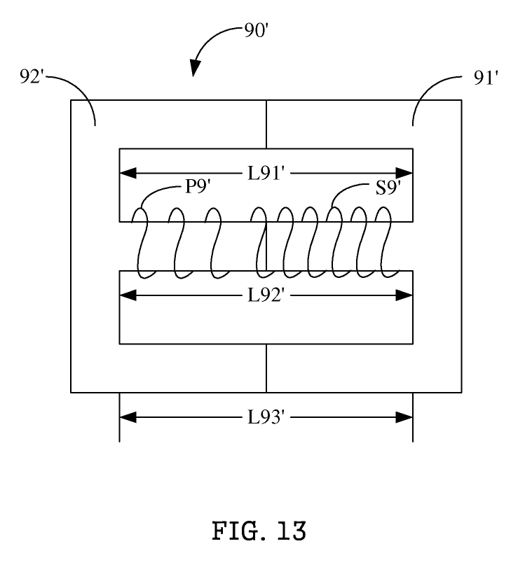

FIG. 13 is a schematic diagram of a thirteenth embodiment of a high voltage transformer 90′, differing from high voltage transformer 90 in that a secondary winding S9′ is wrapped on both the cores 91′, 92′ of the second leg L92′. In detail, a high voltage portion of the secondary winding S9′ and a primary winding P9′ are wrapped on the core 92′, and a low voltage portion of the secondary winding S9′ is wrapped on the core 91′.

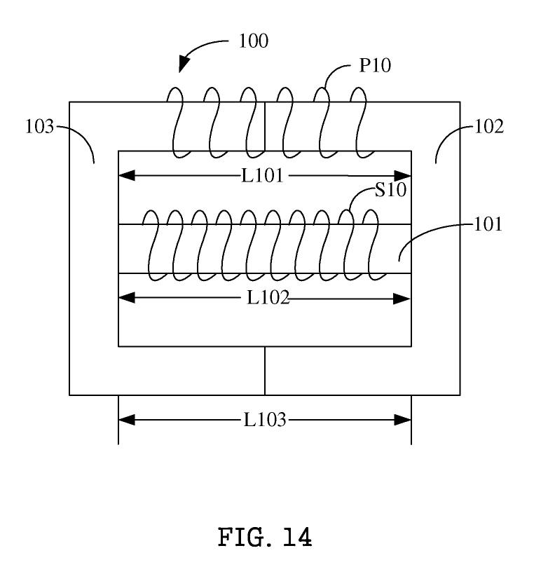

FIG. 14 is a schematic diagram of a fourteenth embodiment of a high voltage transformer 100. The high voltage transformer 100 comprises an “I” type core 101 and at least two “C” type cores 102, 103. As illustrated, the “I” type core 101 is wrapped by a secondary winding S10, and the two “C” type cores 102, 103 are wrapped by a primary winding P10. The cores 101, 102, and 103 form a “ [symbol] ” type core assembly. Similarly, conductive coefficient of the core 101 is at least 100 times of that of the cores 102, 103. The core 101 is made of a manganese-zinc alloy, and the cores 102, 103 are made of a nickel-zinc alloy. The “ [symbol] ” type core assembly comprises a first leg L101, a second leg L102 and a third leg L103. The second leg L102 is the “I” type core wrapped by the secondary winding S10, and the first leg L101 is wrapped by the primary winding P10. The legs L101, L102, L103 are the same length.

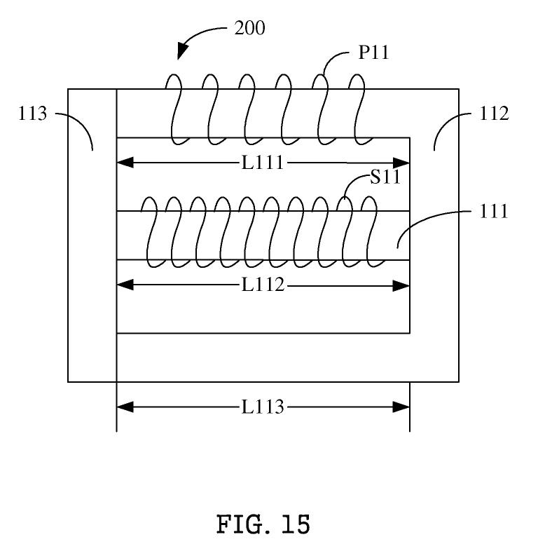

FIG. 15 is a schematic diagram of a fifteenth embodiment of a high voltage transformer 200, differing from high voltage transformer 100 in that the cores 112, 113 of the high voltage transformer 200 form an “CI” type core assembly.

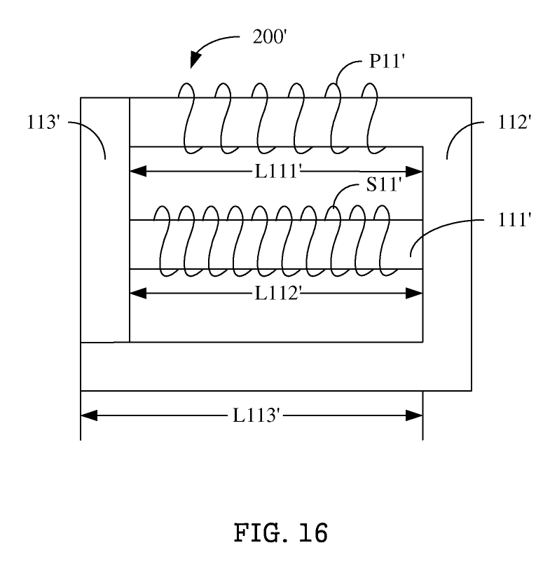

FIG. 16 is a schematic diagram of a sixteenth embodiment of a high voltage transformer 200′, differing from high voltage transformer 200 in that a first leg L111′ and a second leg L112′ are the same length, both being shorter than a third leg L113′.

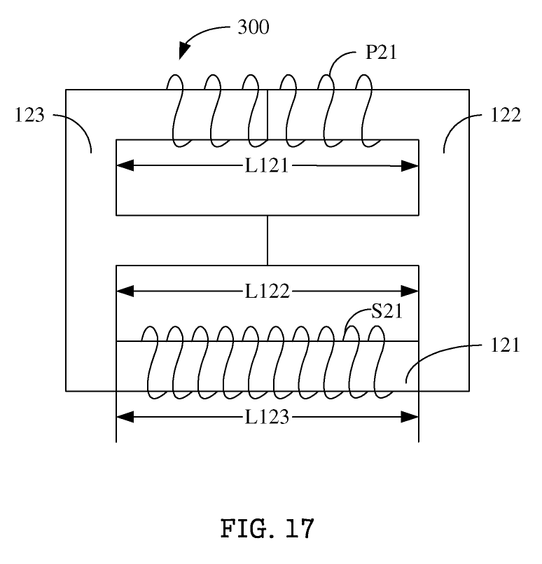

FIG. 17 is a schematic diagram of a seventeenth embodiment of a high voltage transformer 300, differing from high voltage transformer 100 in that the cores 122, 123 of the high voltage transformer 300 form a “FF” core assembly. A third leg L123 is the “I” type core wrapped by a secondary winding S21, and a first leg L121 is wrapped by a primary winding P21.

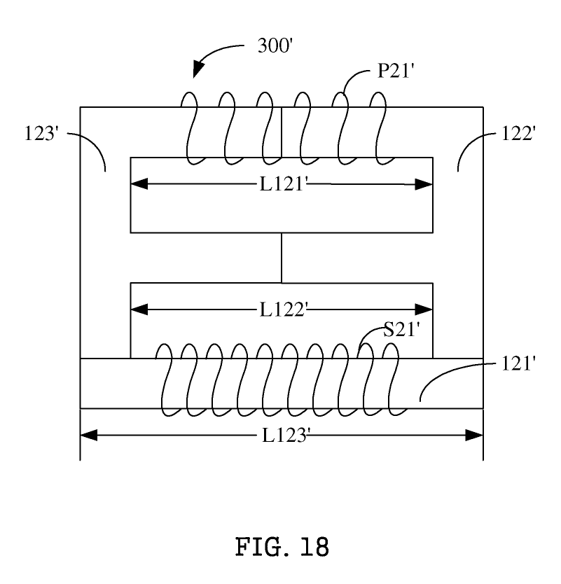

FIG. 18 is a schematic diagram of an eighteenth embodiment of a high voltage transformer 300′, differing from high voltage transformer 90 in that the legs L121′, L122′, L123′ are different lengths. In detail, first leg L121′ and the second leg L122′ are the same length, both being shorter than the third leg L123′.

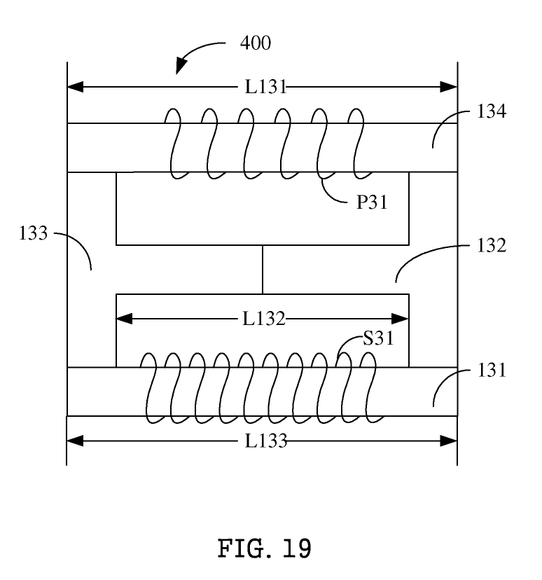

FIG. 19 is a schematic diagram of a nineteenth embodiment of a high voltage transformer 400, differing from high voltage transformer 100 in that the cores 132, 133, 134 form a “TTI” type core assembly. A first leg L131 and a third leg L133 are the Page of same length, both being longer than a second leg L132.

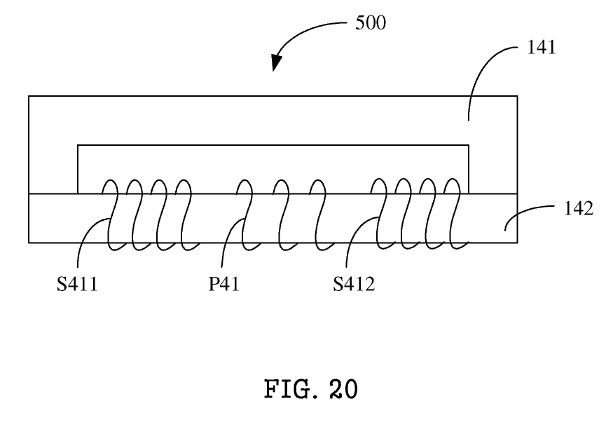

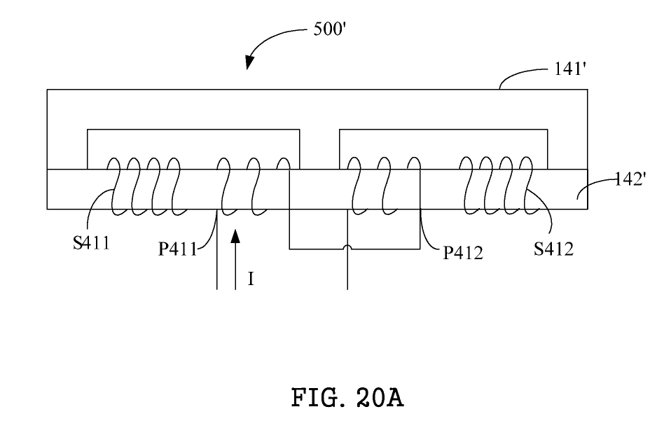

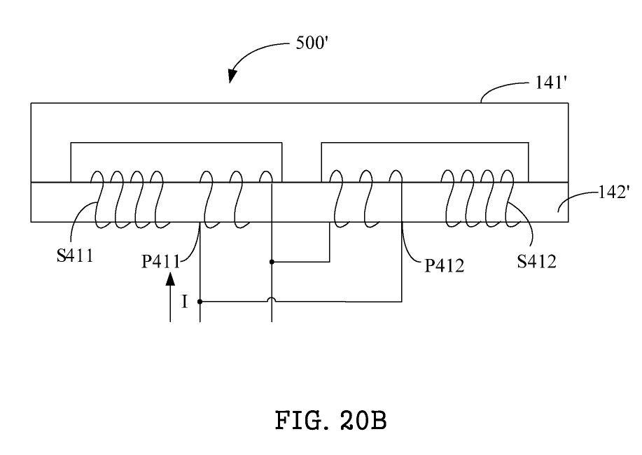

FIG. 20 is a schematic diagram of a twentieth embodiment of a high voltage transformer 500, differing from high voltage transformer 20 of FIG. 2 in that the “I” type core 22 wraps a primary winding P41 and at least two secondary windings S411, S412. In one embodiment, the primary winding P41 is wrapped on the middle of the second core 142, and the at least two secondary windings S411, S412 are wrapped on the both sides of the primary winding P41. Similarly, conductive coefficient of the core 141 is at least 100 times of that of the core 142. The core 141 is made of a manganese-zinc alloy, and the core 142 is made of a nickel-zinc alloy.

FIG. 20A is a schematic diagram of a twenty-first embodiment of a high voltage transformer 500′, differing from high voltage transformer 500 in that the first core 141′ is a “E” type core and the primary winding P41 comprises a first sub primary winding P411 and a second sub primary winding P412. In one embodiment, each the first and the second sub primary winding P411, P412 has a first input and a second input. The first sub primary winding P411 is connected to the second sub primary winding P412 in series. In detail, the first input of the first sub primary winding P411 is connected to the second input of the second sub primary winding P412, and the second input of the first sub primary winding P411 is connected to the first input of the second sub primary winding P412. Therefore, direction of flux generated by the first sub primary winding P411 and the second sub primary winding P412 are opposite. In one embodiment, the first core 141 and the second core 142 form a “ [symbol] ” type core assembly.

FIG. 20B is a schematic diagram of a twenty-second embodiment of a high voltage transformer 500′, differing from high voltage transformer 500′ of FIG. 20A in that the first sub primary winding P411 is connected to the second sub primary winding P412 in parallel. In detail, the first inputs of the first and second sub primary windings P411 and P412 are connected together, and the second input of the first and second sub primary windings P411 and P412 are connected together.

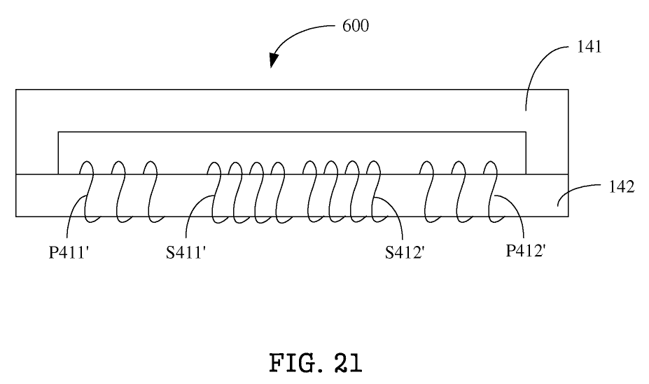

FIG. 21 is a schematic diagram of a twenty-third embodiment of a high voltage transformer 600, differing from high voltage transformer 500 in that the high voltage transformer 600 comprises at least two independent primary windings P411′, P412′ and at least two secondary windings S411′, S412′. The secondary windings S411′, S412′ are wrapped on the middle of the second core 142, and the primary windings P411′, P412′ are wrapped on both sides of the second core 142. Alternatively, the two primary windings P411′, P412′ can be integrated into one primary winding, connected in series or parallel.

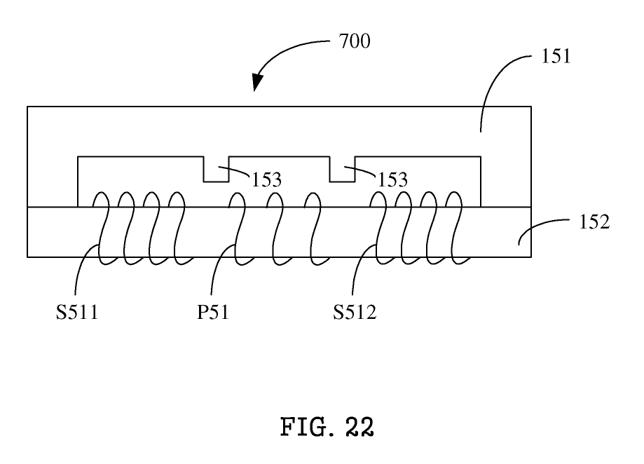

FIG. 22 is a schematic diagram of a twenty-fourth embodiment of a high voltage transformer 700, differing from high voltage transformer 700 in that two protruding portions 153 are disposed on the first core 153 in the high voltage transformer 700. As illustrated, the first core 151 is divided into three portions by the two protruding portions 153. The cores 151, 152 form a “ [symbol] ” type core assembly that comprises three wrapping regions corresponding to the three portions of the first core 151. A primary winding P51 is wrapped on a middle wrapping region of the “ [symbol] ” type core assembly, and the secondary windings S511, S512 are wrapped on both sides wrapping region of the “ [symbol] ” type core assembly.

In high voltage transformers of the disclosure, cores for wrapping secondary windings are made of a nickel-zinc alloy, and other portions of the cores are made of a manganese-zinc alloy, lowering costs and meeting small size and weight requirements of electronic devices.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. A high voltage transformer, comprising:
a first core; and
a second core coupled to the first core, wherein the second core is wrapped by at least one primary winding and at least one secondary winding of the transformer;
wherein the first core is made of manganese-zinc alloy, and the second core is made of nickel-zinc alloy, such that conductive coefficient of the first core is much higher than conductive coefficient of the second core.

2. The high voltage transformer as claimed in claim 1, wherein the second core is an “I” type core.

3. The high voltage transformer as claimed in claim 2, wherein one end of the second core is wrapped by one primary winding and the other end of the second core is wrapped by one secondary winding.

4. The high voltage transformer as claimed in claim 3, wherein the first and the second cores form a “CI”, “MI”, or “ [symbol] I” type core assembly.

5. The high voltage transformer as claimed in claim 2, wherein the second core is wrapped by the at least one primary winding and at least two secondary windings.

6. The high voltage transformer as claimed in claim 5, wherein the first core is a “C” type core.

7. The high voltage transformer as claimed in claim 6, wherein the first core comprises at least two protruding portions and form a “ [symbol] ” type core assembly with the second core.

8. The high voltage transformer as claimed in claim 5, wherein the first core is an “E” type core to form a “ [symbol] ” type core assembly with the second core.

9. The high voltage transformer as claimed in claim 5, wherein the primary windings are wrapped on the middle of the second core, and the secondary windings are wrapped on both ends of the second core.

10. The high voltage transformer as claimed in claim 5, wherein the at least two secondary windings are wrapped on the middle of the second core, and the primary windings are wrapped on both sides of the secondary windings.
